(19) United States
(12) Patent Application Publication
(10) Pub. No.: US 2019/0294924 A1
(43) Pub. Date: Sep. 26, 2019

(54) COMPUTER VISION TRAINING USING PAIRED IMAGE DATA

(71) Applicant: Seesure, Ainslie ACT (AU)

(72) Inventors: Stephen Gould, Ainslie ACT (AU); Samuel Toyer, Ainslie ACT (AU); David Reiner, Yarralmula ACT (AU)

(21) Appl. No.: 16/360,954

(22) Filed: Mar. 21, 2019

Related U.S. Application Data
(60) Provisional application No. 62/646,304, filed on Mar. 21, 2018.

(51) Int. Cl. G06K 9/62; G06N 3/08; G06T 1/20; G06T 1/00

(52) U.S. Cl. CPC G06K 9/6256; G06T 1/0014; G06T 1/20; G06N 3/08

(57) ABSTRACT

A method of training a computer vision to visually recognize and identify objects includes, in part, supplying N pairs of images to the computer with each pair including first and second images. The first image in each pair includes data representative of a scene as well as an object to be recognized. The second image of each pair includes only the data representative of the scence and thus does not include the object. The training method may further include minimizing a loss function represented by a sum, over all N images, of a conditional probability of finding the object in the i-th image and a conditional probability of not finding the object in the i-th image.

### CROSS-REFERENCE TO RELATED APPLICATION

The present application claims benefit to U.S. Patent Application No. 62/646,304, filed Mar. 21, 2018, the content of which is incorporated herein by reference in its entirety.

### FIELD OF THE INVENTION

The present invention relates to artificial intelligence, and more particularly to computer vision.

### BACKGROUND OF THE INVENTION

Conventional computer vision models for tasks such as object detection, image segmentation and human pose estimation are trained using an annotated set of training images. Such images are usually collected to represent a diverse set of scenes that are similar to what the system expects to see when deployed (i.e., at test time). Bounding box annotations, pixelwise masks, or image coordinates with labels are used to denote the location of objects and landmarks in the scene. Supervised machine learning training algorithms then use this information to tune model parameters such as the weights in a convolutional neural network. Models can extract cues from both within the annotated region (such as shape, color and texture) and outside it (often referred to as contextual information) to help detect and classify objects.

FIGS. 1A and 1B are schematic illustrations of two images from a dataset used for training a computer vision algorithm, as known in the prior art. The scene depicted in FIG. 1A includes a person 10 standing in front a snow-capped mountain 12. The scene depicted in FIG. 1B shows a tree 20 but does not include a person. In this example, the first image 1A is labelled as positive for the task of person detection (i.e., because it shows a person) and the second image 1B is labelled as negative (i.e., because it does not show a person). Alternatively, instead of labelling the first image 1A as positive, the location of the person in the first image 1A may be annotated by a bounding box or body joint locations such as the position of the head, shoulders, hands, feet, and the like, as is also known.

While this approach to training computer vision models is conceptually sound, it relies on sufficient diversity in the dataset to distinguish, for example, between the real signal and any inherent bias in the data, such as when certain objects only appear in certain contexts, at certain locations in the image, or at certain scales. This poses particular challenges in deep learning models where cues are extracted and weighted automatically and without human guidance. When there is insufficient diversity in the training data, the computer vision model often locks onto spurious signals in the training data that do not reliably generalize to data not seen during training.

Obtaining sufficient diversity is challenging. It is also difficult to evaluate whether a dataset contains enough variability for the trained models to perform well on unseen images. Even very large datasets are limited in their diversity and hence are susceptible to the problem of learning the peculiarities of the data rather than the task at hand. One state-of-the-art method for helping to overcome this problem is known as data augmentation. In the data augmentation method, images are slightly modified during each training cycle to introduce small perturbations in the training signal. However, data augmentation does not mitigate the underlying problem of dataset bias. As such, the resulting computer vision models can still be very brittle and perform poorly on new data presented at test time. A need continues to exist for improvement in training a computer vision model.

### BRIEF SUMMARY OF THE INVENTION

A method of training a computer vision algorithm to visually recognize and identify objects, in accordance with one embodiment of the present invention, includes, in part, supplying N pairs of images to the computer with each pair including first and second images. The first image in each pair includes data representative of a scene as well as an object the computer is being trained to recognize. The second image of each pair includes only the data representative of the scence. Accordingly, in the second image the object is not present.

The method, in accordance with one embodiment of the present invention, includes, in part, minimizing a loss function represented by a sum, over all N images, of a conditional probability of finding the object in the i-th image and a conditional probability of not finding the object in the i-th image. It is understood that i is an index ranging from 1 to N.

In one embodiment, the method further includes, in part, minimizing a loss function represented by a sum, over all N images, of a square of a conditional probability of finding the object in the i-th image and a square of a conditional probability of not finding the object in the i-th image.

In one embodiment, the second image of each of at least a subset of the N image pairs is generated by a graphics engine from the first image associated with the second image. In one embodiment, the first and second images of each of at least a subset of the N image pairs are generated synthetically by a graphics engine. In one embodiment, the second images of each of at least a subset of the N image pairs is generated by either adding or removing objects from the first image associated with the second image. In one embodiment, the method further includes, in part, taking a gradient of the loss function.

A computer system, in accordance with one embodiment of the present invention, is trained to visually recognize and identify objects by receiving N pairs of images. Each pair includes, in part, first and second images. The first image in each pair includes data representative of a scene as well as an object the computer is being trained to recognize. The second image of each pair includes only the data representative of the scence. Accordingly, in the second image the object is not present.

In one embodiment, the computer system is configured to minimize a loss function represented by a sum, over all N images, of a conditional probability of finding the object in the i-th image and a conditional probability of not finding the object in the i-th image. In one embodiment, the computer system is configured to minimize a loss function represented by a sum, over all N images, of a square of a conditional probability of finding the object in the i-th image and a square of conditional probability of not finding the object in the i-th image.

In one embodiment, the second image of each of at least a subset of the N image pairs is generated by a graphics engine from the first image associated with the second image. In one embodiment, the first and second images of each of at least a subset of the N image pairs are generated synthetically by a graphics engine. In one embodiment, the second images of each of at least a subset of the N image pairs is generated by either adding or removing objects from the first image associated with the second image. In one embodiment, the computer system is further configured to take a gradient of the loss function.

### BRIEF DESCRIPTION OF THE DRAWINGS

FIGS. 1A and 1B are schematic illustrations of two images used for training a computer vision algorithm, as known in the prior art.

FIGS. 2A and 2B are schematic illustrations of two images used for training a computer vision algorithm, in accordance with one embodiment of the present invention.

FIGS. 3A and 4B are schematic illustrations of two images used for training a computer vision algorithm, in accordance with one embodiment of the present invention.

FIG. 4 is a simplified block diagram of a computer system configured to be trained, in accordance with one embodiment of the present invention.

### DETAILED DESCRIPTION OF THE INVENTION

In accordance with one embodiment of the preset invention, a dataset containing image pairs is used to train a computer vision model. Each image in the pair depicts almost identical scenes where one or more specific aspects are changed in a controlled manner, as described further below.

To train an algorithms for a computer vision model an annotated set of image-label data [symbol] ={(xᵢ, yᵢ)}ᵢ₌₁ⁿ is provided to the computer algorithm. The aim is to find parameters θ of the model that minimize a loss function L( [symbol] , θ), which measures how well the model performs on the training dataset. In the above expression n represents the number of examples in the dataset, xᵢ represents the i-th image in the dataset (or features extracted from the image) and yᵢ represents its annotation or label. For example, in the context of object detection, the features may be the Red, Green, Blue (RGB) values for each pixel in the image and the label may be the number one “1” when an object of interest is present in the image, and the number zero “0” when that the object is absent from the image. The model may output a conditional probability estimate \hat{p}_{θ}(y|xᵢ) for each of the possible labels given the image, which can be turned into a classification by thresholding the probability for accepting a label as positive (i.e., object present).

Conventional training algorithms for computer vision models operate iteratively with the aim of decreasing the loss function during each iteration, or epoch, until convergence or a maximum number of epochs is reached. On very large datasets, each iteration of the training algorithms operates on a subset of the dataset sometimes known as a mini-batch. In such cases, multiple iterations form a training epoch. In deep learning models the method of choice for decreasing the loss function may be a variant of gradient or stochastic gradient descent and may take hundreds of thousands of iterations to converge.

Embodiments of the present invention overcome the above-mentioned problems by providing an explicit training signal for the task at hand. In one embodiment, the computer vision model is trained by receiving a dataset containing pairs of images rather than a dataset of random positive and negative examples. Each image in the pair depicts almost identical scenes where one or more specific aspects are changed in a controlled manner to distinguish between positive and negative examples. For example, when training an object detection model, each training example includes a pair of images in one of which the object is present and in the other one of which the object is absent; the two images otherwise depict nearly identical scenes. By using this information, the model leverages contextual information but minimizes the bias by having visually near identical positive and negative examples outside of the pixels containing the person, as well as visual influences such as shadows. Yet, it still allows contextual information to be learned by the model (e.g., a shadow provides supporting evidence for the presence of a person).

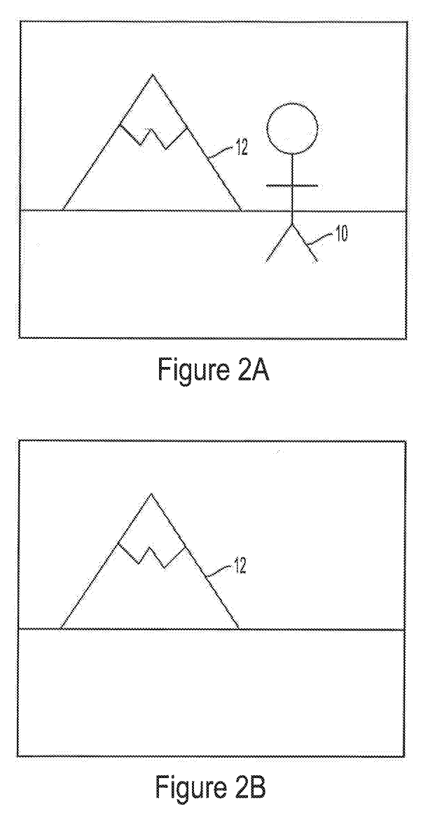

It is understood that when an object is present in one image in a pair and absent from the other image in the pair, as shown in exemplary FIGS. 2A and 2B, then all evidence of the object is also absent from the other image. For example, if an object casts a shadow or reflection when present in a scene then that shadow or reflection should not be present in the image where the object is not present. Likewise, if an object is partially covering other objects or background regions in a scene then when that object is absent those other objects or background regions will become visible.

FIGS. 2A and 2B show a pair of images used in training a computer vision model, in accordance with one exemplary embodiment of the present invention. FIG. 2A shows a person 12 standing in front of a snow-capped mountain 12. FIG. 2B shows snow-capped mountain 12 without person 12. In other words, the only difference between images 2A and 2B is that image 2A shows a person in the scene while second image 2B does not. Such image pairs can be generated by synthesizing the scene using a graphics engine or collected manually by adding and removing objects from the scene as data is acquired. Such image pairs may also be generated semi-autonomously through image-editing algorithms.

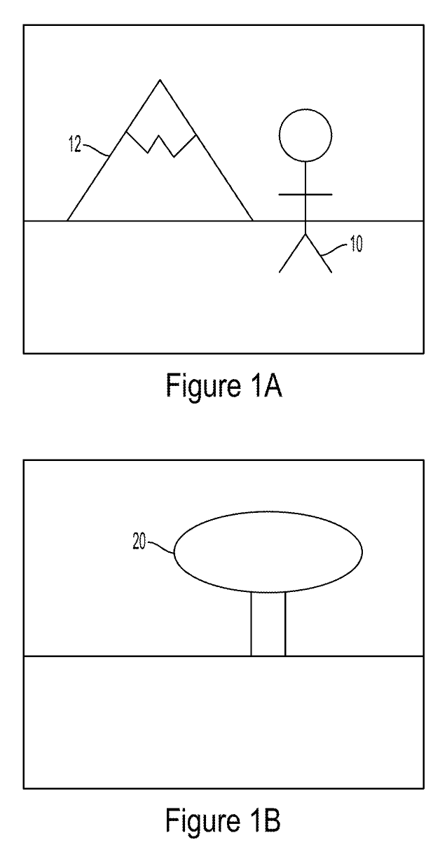

By way of example the object in FIGS. 1A and 2A is a person but could be any other object or landmark for the purposes of the current invention. For example, the object could be another tangible object such as a car or a dog; it could be background regions such as trees and buildings; or it could be landmarks such as a person's hand or foot.

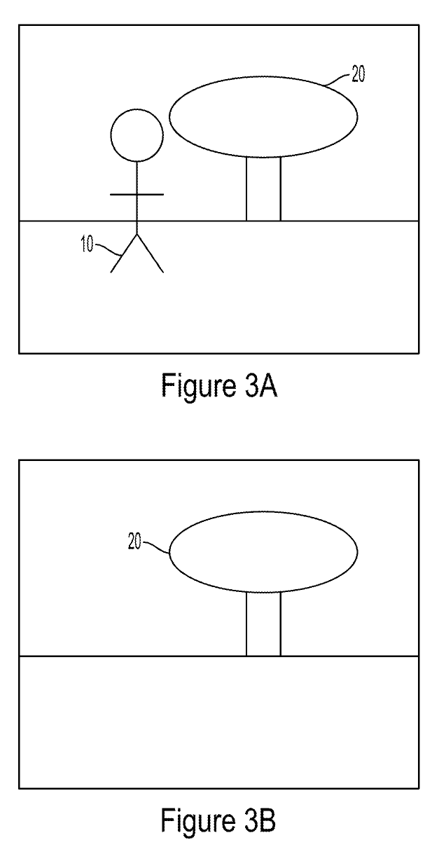

It is understood that to train a computer vision model many thousands or millions of image pairs, such as the image pair shown in FIGS. 2A and 2B, are needed. FIGS. 3A and 3B show a pair of images used in training a computer vision model, in accordance with another exemplary embodiment of the present invention. FIG. 3A shows a person 12 standing in front of a tree 20. FIG. 3B shows tree 20 without person 12. In other words, the only difference between images 3A and 3B is that image 3A contains a person in the scene while image 3B does not. As seen from each image pair 2A/2B and/or 3A/3B, in each image pair the scene is identical other than the presence of a person in the first image of the pair and the absence of the person in the second image. By having such a paired image dataset, a computer vision model is trained to recognize a person by distinguishing between images that contain people and those that do not.

In accordance with one embodiment of the present invention, the loss function is defined as the cross-entropy loss, which for a given batch or dataset [symbol] ={(xᵢ, yᵢ)}ᵢ₌₁ⁿ over binary labels yᵢ∈{0,1} may be defined as:

L( [symbol] ,θ)=−Σᵢ₌₁ⁿyᵢ log \hat{p}_{θ}(1|xᵢ)+(1−yᵢ)log \hat{p}_{θ}(0|xᵢ) (1)

Therefore, in accordance with one embodiment of the present invention, the loss function—represented by a value defined by a sum of (i) a conditional probability of finding the object in the i-th image (\hat{p}_{θ}(1|xᵢ)) multiplied by the i-th-image's label yᵢ and (ii) a conditional probability of not finding the object in the i-th image (\hat{p}_{θ}(0|xᵢ)) multiplied by (1−(i-th-image's label)) over all the images (i.e., from i=1 to i=n, where n represents the number of paired images)—is minimized. Therefore, in contrast to conventional systems which perform their training using a set of images with corresponding labels, a computer vision model, in accordance with one embodiment of the present invention, is trained using paired images, with one image in each pair containing the object of interest and the other image in the pair not containing the object of interest, and with the scenes depicted by the two images (also referred to herein as associated pair of images) being otherwise identical. Herein the image containing the object of interest is alternatively referred to as the positive image in the pair, denoted as xᵢ⁺, and the image not containing the object of interest is alternatively referred to as the negative image in the pair, denoted as xᵢ⁻.

The cross-entropy loss on the paired-image dataset [symbol] ^{paired}={(xᵢ⁺, xᵢ⁻)}ᵢ₌₁ⁿ may also be defined as:

L( [symbol] ^{paired}, θ)=−Σᵢ₌₁ⁿ log \hat{p}_{θ}(1|xᵢ⁺)+log \hat{p}_{θ}(0|xᵢ⁻) (2)

In both expressions (1) and (2), the loss function L is summed over all images in the entire dataset or its subset (mini-batch) for each training iteration. The gradient estimates for the loss function over a paired-image dataset [symbol] ^{paired} can be calculated in a similar way as gradients for the loss function over [symbol] . Therefore, embodiments of the present invention can make use of existing hardware and software frameworks used, for example, to train deep learning models.

Because, the positive and negative images provided to the loss function, in accordance with embodiments of the present invention, depict the same scene while only differing in the absence or presence of the object (signal) for the task at hand, embodiments of the present invention provide a much stronger training signal and reduce the effect of dataset bias. Therefore, the resulting computer vision models, in accordance with embodiments of the present invention, are more robust and perform substantially better when run on data not seen during training. This is especially true for smaller sets of image pairs (mini-batches) where diversity is limited and noisy gradient estimates can result.

For example, referring to FIGS. 2A and 2B, a computer vision model formed using embodiments of the present invention will not confuse a snow-capped mountain for a person since the same snow-capped mountain appears in both positive and negative images. In contrast, a model trained using conventional techniques may incorrectly predict that all mountain scenes contain people.

In accordance with another embodiment of the present invention, the loss function is defined as the square loss. As shown above, for a given mini-batch or dataset [symbol] ={(xᵢ, yᵢ)}ᵢ₌₁ⁿ over binary labels yᵢ∈{0,1} the loss function may be defined as:

L^{sq}( [symbol] , θ)=Σᵢ₌₁ⁿ(yᵢ−\hat{p}_{θ}(1|xᵢ))² (3)

On a paired image dataset [symbol] ^{paired}={(xᵢ⁺, xₓ⁻)}ᵢ₌₁ⁿ, the loss function may be defined as:

L^{sq}( [symbol] ^{paired}, θ)=Σᵢ₌₁ⁿ(1−\hat{p}_{θ}(1|xᵢ⁺))²+(0−\hat{p}_{θ}(0|xᵢ⁻))² (4)

It is understood that embodiments of the present invention are not limited to the cross-entropy loss or square loss functions and that training on paired-images may be performed with any loss function or training objective.

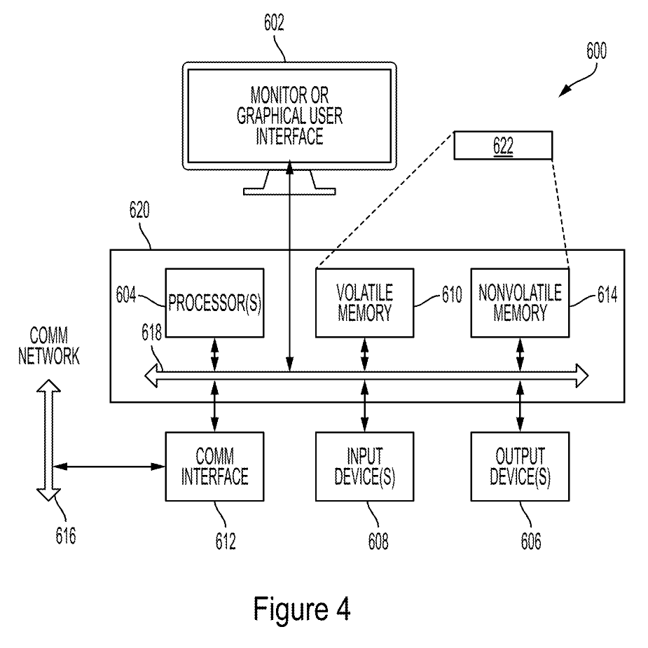

FIG. 4 is an example block diagram of a computing device 600 that may incorporate embodiments of the present invention and used for vision training. FIG. 4 is merely illustrative of a machine system to carry out aspects of the technical processes described herein, and does not limit the scope of the claims. One of ordinary skill in the art would recognize other variations, modifications, and alternatives. In one embodiment, the computing device 600 includes a monitor or graphical user interface 602, a data processing system 620, a communication network interface 612, input device(s) 608, output device(s) 606, and the like.

As depicted in FIG. 4, the data processing system 620 may include, for example, one or more central processing units (CPU), graphical processing units 604, or any other hardware processor or accelerator such as TensorFlow Processing Unit (TPU) (collectively referred to herein as processor(s)) that communicate with a number of peripheral devices via a bus subsystem 618. These peripheral devices may include input device(s) 608, output device(s) 606, communication network interface 612, and a storage subsystem, such as a volatile memory 610 and a nonvolatile memory 614.

The volatile memory 610 and/or the nonvolatile memory 614 may store computer-executable instructions and thus forming logic 622 that when applied to and executed by the processor(s) 604 implement embodiments of the processes disclosed herein.

The input device(s) 608 include devices and mechanisms for inputting information to the data processing system 620. These may include a keyboard, a keypad, a touch screen incorporated into the monitor or graphical user interface 602, audio input devices such as voice recognition systems, microphones, and other types of input devices. In various embodiments, the input device(s) 608 may be embodied as a computer mouse, a trackball, a track pad, a joystick, wireless remote, drawing tablet, voice command system, eye tracking system, and the like. The input device(s) 608 typically allow a user to select objects, icons, control areas, text and the like that appear on the monitor or graphical user interface 602 via a command such as a click of a button or the like.

The output device(s) 606 include devices and mechanisms for outputting information from the data processing system 620. These may include speakers, printers, infrared LEDs, and so on as well understood in the art.

The communication network interface 612 provides an interface to communication networks (e.g., communication network 616) and devices external to the data processing system 620. The communication network interface 612 may serve as an interface for receiving data from and transmitting data to other systems. Embodiments of the communication network interface 612 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 612 may be coupled to the communication network 616 via an antenna, a cable, or the like. In some embodiments, the communication network interface 612 may be physically integrated on a circuit board of the data processing system 620, or in some cases may be implemented in software or firmware, such as “soft modems”, or the like.

The computing device 600 may include logic that enables communications over a network using protocols such as HTTP, TCP/IP, RTP/RTSP, IPX, UDP and the like.

The volatile memory 610 and the nonvolatile memory 614 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 610 and the nonvolatile memory 614 may be configured to store the basic programming and data constructs that provide the functionality of the disclosed processes and other embodiments thereof that fall within the scope of the present invention.

Logic 622 that implements embodiments of the present invention may be stored in the volatile memory 610 and/or the nonvolatile memory 614. Said software may be read from the volatile memory 610 and/or nonvolatile memory 614 and executed by the processor(s) 604. The volatile memory 610 and the nonvolatile memory 614 may also provide a repository for storing data used by the software.

The volatile memory 610 and the nonvolatile memory 614 may include a number of memories including a main random access memory (RAM) for storage of instructions and data during program execution and a read only memory (ROM) in which read-only non-transitory instructions are stored. The volatile memory 610 and the nonvolatile memory 614 may include a file storage subsystem providing persistent (non-volatile) storage for program and data files. The volatile memory 610 and the nonvolatile memory 614 may include removable storage systems, such as removable flash memory.

The bus subsystem 618 provides a mechanism for enabling the various components and subsystems of data processing system 620 communicate with each other as intended. Although the communication network interface 612 is depicted schematically as a single bus, some embodiments of the bus subsystem 618 may utilize multiple distinct busses.

It will be readily apparent to one of ordinary skill in the art that the computing device 600 may be a device such as a smartphone, a desktop computer, a laptop computer, a rack-mounted computer system, a computer server, or a tablet computer device. As commonly known in the art, the computing device 600 may be implemented as a collection of multiple networked computing devices. Further, the computing device 600 will typically include operating system logic (not illustrated) the types and nature of which are well known in the art.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

What is claimed is:

1. A method of training a computer vision algorithm by training the computer to visually recognize and identify objects, the method comprising:
supplying N pairs of images to the computer, each pair comprising first and second images, wherein a first image of each pair comprises data representative of a scene and an object, and wherein a second image of each pair includes only the data representative of the scence, wherein N is an integer greater than one.

2. The method of claim 1 further comprising:
minimizing a loss function represented by a sum, over all N images, of a conditional probability of finding the object in the i-th image and a conditional probability of not finding the object in the i-th image, wherein i is an index ranging from 1 to N.

3. The method of claim 1 further comprising:
minimizing a loss function represented by a sum, over all N images, of a square of a conditional probability of finding the object in the i-th image and a square of a conditional probability of not finding the object in the i-th image.

4. The method of claim 1 further wherein the second image of each of at least a subset of the N image pairs is generated by a graphics engine from the second image's associated first image.

5. The method of claim 1 wherein the first and second images of each of at least a subset of the N image pairs are generated synthetically by a graphics engine.

6. The method of claim 4 wherein the second images of each of at least a subset of the N image pairs is generated by either adding or removing objects from the second image's associated first image.

7. The method of claim 2 further comprising:
taking a gradient of the loss function.

8. A computer system trained to visually recognize and identify objects by receiving N pairs of images, each pair comprising first and second images, wherein a first image of each pair comprises data representative of a scene and an object, and wherein a second image of each pair includes only the data representative of the scence.

9. The computer system of claim 9 wherein said computer system is configured to minimize a loss function represented by a sum, over all N images, of a conditional probability of finding the object in the i-th image and a conditional probability of not finding the object in the i-th image.

10. The computer system of claim 9 wherein said computer system is configured to minimize a loss function represented by a sum, over all N images, of a square of a conditional probability of finding the object in the i-th image and a square of conditional probability of not finding the object in the i-th image

11. The computer system of claim 9 wherein the second image of each of at least a subset of the N image pairs is generated by a graphics engine from the second image's associated first image.

12. The computer system of claim 9 wherein the first and second images of each of at least a subset of the N image pairs are generated synthetically by a graphics engine

13. The computer system of claim 11 wherein the second images of each of at least a subset of the N image pairs is generated by either adding or removing objects from the second image's associated first image.

14. The computer system of claim 10 wherein the computer system is further configured to take a gradient of the loss function.
